(19) United States
(12) Patent Application Publication
(10) Pub. No.: US 2009/0074211 A1
(43) Pub. Date: Mar. 19, 2009

(54) CAPACITOR MICROPHONE AND METHOD FOR MANUFACTURING CAPACITOR MICROPHONE

(75) Inventors: Seiji Hirade, Fukuroi-shi (JP); Shingo Sakakibara, Hamamatsu-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: YAMAHA CORPORATION, Hamamatsu-Shi (JP)

(21) Appl. No.: 12/065,173

(22) PCT Filed: Aug. 30, 2006
(86) PCT No.: PCT/JP2006/317134

§ 371 Date: May 30, 2008

(30) Foreign Application Priority Data
Aug. 30, 2005 (JP) 2005-249458
Jan. 27, 2006 (JP) 2006-018834

(51) Int. Cl. H04R 19/04

(52) U.S. Cl. 381/174

(57) ABSTRACT

A capacitor microphone includes a plate that has a fixed electrode, a diaphragm that has a variable electrode, the plate that vibrates by sound waves, and a spacer that insulates and supports the plate and the diaphragm forming airspace between the fixed electrode and the variable electrode, wherein at least either of the plate or the diaphragm is a semiconductor single-layered film or a metal single-layered film whose specific resistance in a nearby edge close to the spacer is higher than that in a central unit away from the spacer.

### TECHNICAL FIELD

The present invention relates to a capacitor microphone and a method for manufacturing the capacitor microphone, particularly to a capacitor microphone film and a method for manufacturing the capacitor microphone film.

Priority is claimed on Japanese Patent Application No. 2005-249458, filed Aug. 30, 2005, and Japanese Patent Application No. 2006-018834 filed Jan. 27, 2006, the contents of which are incorporated herein by reference.

### BACKGROUND ART

A capacitor microphone is conventionally known as a product that can be manufactured with applications of manufacturing processes for a semiconductor device. A capacitor microphone has respective electrodes on a plate and a diaphragm that is vibrating with sound waves; the plate and the diaphragm are supported in a state where both of them are kept separated by an insulating spacer. A capacitor microphone converts capacity changes, caused by the displacement of a diaphragm, into electric signals and outputs the same. Sensitivity of the capacitor microphone is improved by increasing the displacement of the diaphragm and reducing the leak current of the spacer and parasitic capacity.

The non-patent document 1 discloses a capacitor microphone that is structured with conductive thin films, respectively for a plate and a diaphragm vibrated by sound waves. However, edges fixed at a spacer rarely change, even if the sound waves are propagated to the diaphragm so that the edges, which are respectively fixed at the diaphragm including the conductive thin films and at the spacer on the plate, reduce the sensitivity of the capacitor microphone by means of forming parasitic capacity.

The patent document 1 discloses a capacitor microphone that is equipped with a diaphragm that is composed of an electrode made of conductive materials fixed at the center of the insulating films. This structure has a problem where the manufacturing yield is reducing and the manufacturing costs are increasing because of complex manufacturing steps; even though the parasitic capacity is reducing. It is also a factor to drive up the manufacturing costs that the insulating films, that fix the electrode, are etched in the step of removing a sacrifice layer forming airspace between the diaphragm and the plate with etching, so that a countermeasure for this event is needed to be incorporated in the process.
Non-patent document 1: The Institute of Electrical Engineers in Japan MSS-01-34 (NHK)
Patent document 1: Published Japanese Translation No. 2004-506394 of the PCT International Publication (JP-A No. 2004-506394)

### DISCLOSURE OF INVENTION

The present invention is aimed to provide a capacitor microphone of which sensitivity is high and manufacturing costs are low, and a method for manufacturing the same.

In order to achieve the above purpose of the invention, means for solving the problems are provided as follows:

(1) The capacitor microphone is equipped with a plate having a fixed electrode, a diaphragm having a variable electrode and vibrating by sound waves, and a spacer that insulates and supports the plate and the diaphragm and forms airspace between the fixed electrode and the variable electrode; wherein at least either of the plate or the diaphragm is a semiconductor single-layered film or a metal single-layered film of which specific resistance in a nearby edge close to the spacer is higher than that in a central unit away from the spacer.

The sensitivity of the capacitor microphone becomes higher because capacity with less capacity changes; in other words, the parasitic capacity can be reduced by means of having at least one part of the higher specific resistance in the nearby edge close to the spacer on at least either of the plate or the diaphragm than the other units. A high sensitive capacitor microphone can be manufactured with lower costs by means of structuring a plate or a diaphragm with semiconductor single-layered film or a metal single-layered film of which specific resistance is different depending on a region, resulting in simplifying manufacturing processes of a capacitor microphone.

(2) Impurities may be diffused into the nearby edge.

(3) The central unit may be formed with silicone and the nearby edge may be formed with nitriding silicon.

(4) The central unit may be formed with silicone and the nearby edge may be formed with oxynitriding silicon.

(5) Thickness of the nearby edge may be thicker than that of the central unit.

(6) A method for manufacturing a capacitor microphone that is equipped with a plate having a fixed electrode, a diaphragm having a variable electrode and vibrating by sound waves, and a spacer that insulates and supports the plate and the diaphragm and forms airspace between the fixed electrode and the variable electrode, includes the steps of: forming a semiconductor single-layered film or a metal single-layered film to provide at least either of the plate or the diaphragm; and changing a specific resistance in a nearby edge of the semiconductor single-layered film or the metal single-layered film close to the spacer to be higher than that in a central unit away from the spacer.

The sensitivity of the capacitor microphone becomes higher because capacity with less capacity changes; in other words, the parasitic capacity can be reduced by means of having higher specific resistance in the nearby edge close to the spacer on at least either of the plate or the diaphragm than the central unit. Manufacturing costs for high sensitive capacitor microphones can be reduced by means of reforming semiconductor single-layered films or metal single-layered films to definitely form regions with high specific resistance, so that manufacturing processes of capacitor microphones become simplified and specific resistance of the nearby edge close to a plate or a spacer can become higher than that in other units.

(7) The nearby edge may be changed by ion-implanting in a state that the central unit of the semiconductor single-layered film or the metal single-layered film is kept masked. Specific resistance increases in the regions where ions are implanted because they become amorphous. Therefore, specific resistance in the nearby edge close to a spacer of a plate or a diaphragm can become higher than that in other units by modifying with ion-implanting without implementing an annealing step of activating ions.

(8) The nearby edge may be changed by ion-implanting the semiconductor single-layered film or the metal single-layered film in a state that the central unit of the semiconductor single-layered film or the metal single-layered film is kept masked, and by activating the ion by annealing.

For example, the nearby edge on a semiconductor single-layered film or a metal single-layered film can be insulated by annealing after implanting oxygen ions or nitrogen ions.

(9) The nearby edge may be changed by thermal oxidation in a state that the central unit of the silicon film, as the semiconductor single-layered film is kept masked.

Film thickness of the nearby edge on the semiconductor single-layered film or the metal single-layered film can be increased by thermal oxidation that insulates the nearby edge of the semiconductor single-layered film or the metal single-layered film.

(10) The nearby edge may be changed by plasma polymerization in a state that the central unit of the semiconductor single-layered film or the metal single-layered film is kept masked.

(11) In order to solve the above problem, a capacitor microphone includes: a plate having a fixed electrode and through-holes, a diaphragm having a variable electrode and vibrating by sound waves, and a spacer that insulates and supports the plate and the diaphragm and forms airspace between the fixed electrode and the variable electrode; wherein at least either of the plate or the diaphragm is a semiconductor single-layered film of which specific resistance in at least one part of the nearby edge close to the spacer is higher than that in other units.

The sensitivity of the capacitor microphone becomes higher with specific resistance in at least one part of the nearby edge close to at least either one spacer of the plate having through-holes or the diaphragm vibrating by sound waves higher than that of the other units. A high sensitive capacitor microphone can be manufactured with lower costs by means of structuring a plate or a diaphragm with semiconductor single-layered film of which specific resistance is different depending on a region, resulting in simplifying the structure of a capacitor microphone.

(12) The semiconductor single-layered film may contain in the central unit impurities acting as donors or acceptors diffused with concentrations higher than at least one part of the nearby edge.

(13) The semiconductor single-layered film may contain the first impurities, as described above, and the second impurities for forming an inverted conductive type semiconductor surrounding the central unit; wherein the second impurities are diffused with a concentration lower than that of the first impurities.

The sensitivity of the capacitor microphone further becomes higher because impurity diffusion that forms an electrode and the second impurities for forming an inverted conductive type semiconductor surrounding the central unit, where the first impurities are diffused, can provide larger electric barriers surrounding the regions where the first impurities are diffused.

(14) A method for manufacturing a capacitor microphone that is equipped with a plate having a fixed electrode and through-holes, a diaphragm having a variable electrode and vibrating by sound waves, and a spacer that insulates and supports the plate and the diaphragm and forms airspace between the fixed electrode and the variable electrode, includes the steps of: forming a semiconductor single-layered film to provide at least either of the plate or the diaphragm; and doping impurities acting as donors or acceptors are doped into regions, excluding at least one part of the nearby edge close to the spacer of the semiconductor single-layered film with a concentration higher than that in at least one part of the nearby edge close to the spacer of the semiconductor single-layered film.

The sensitivity of the capacitor microphone becomes higher when a specific resistance in at least one part of the nearby edge close to at least either one spacer of the plate having through-holes or the diaphragm vibrating by sound waves becomes higher than that of the central unit. Manufacturing costs for high sensitive capacitor microphones can be reduced by means of doping impurities to semiconductor single-layered films to definitely form regions with high specific resistance, so that the structure of the capacitor microphones become simplified and specific resistance of the nearby unit close to a plate or a spacer can become higher than that in other units.

(15) The method for manufacturing the capacitor microphones may include the steps of ion-implanting the impurities into the semiconductor single-layered film, and annealing the semiconductor single-layered film that are ion-implanted with the impurities.

Ion-implanting and doping the impurities into the semiconductor single-layered film can accurately control the distribution of the impurities and reduce the process temperatures.

(16) The method for manufacturing the capacitor microphones may include the step of doping the first impurities, as the above impurities, and the second impurities for forming inverted conductive type semiconductor surrounding the central unit of the semiconductor single-layered film.

The sensitivity of the capacitor microphone further becomes higher because doping the first impurities and the second impurities for forming an inverted conductive type semiconductor surrounding the central unit, where the first impurities are doped, can provide larger electric barriers surrounding the regions where the first impurities of the semiconductor single-layered film are doped.

It should be noted that the procedures of the operations for the above-described method are not limited, unless otherwise specified to the order of the description; therefore, the method can be sequentially or simultaneously implemented with any order of the steps.

### BRIEF DESCRIPTION OF THE DRAWINGS

FIG. 1A is a plain view that illustrates a diaphragm of the capacitor microphone according to the first embodiment of the present invention.

FIG. 1B is a pattern diagram that illustrates a capacitor microphone according to the first embodiment of the present invention.

FIG. 2A is a circuit diagram that illustrates an equivalent circuit in a diaphragm of the capacitor microphone according to the first embodiment of the present invention.

FIG. 2B is a circuit diagram that illustrates an equivalent circuit in a diaphragm of the capacitor microphone having an internal resistance according to the first embodiment of the present invention.

FIG. 3A is a cross-sectional view that illustrates a method for manufacturing the capacitor microphone according to the first embodiment of the present invention.

FIG. 3B is a cross-sectional view that illustrates a method for manufacturing the capacitor microphone according to the first embodiment of the present invention.

FIG. 3C is a cross-sectional view that illustrates a method for manufacturing the capacitor microphone according to the first embodiment of the present invention.

FIG. 3D is a cross-sectional view that illustrates a method for manufacturing the capacitor microphone according to the first embodiment of the present invention.

FIG. 4A is a cross-sectional view that illustrates a method for manufacturing the capacitor microphone according to the first embodiment of the present invention.

FIG. 4B is a cross-sectional view that illustrates a method for manufacturing the capacitor microphone according to the first embodiment of the present invention.

FIG. 4C is a cross-sectional view that illustrates a method for manufacturing the capacitor microphone according to the first embodiment of the present invention.

FIG. 5A is a cross-sectional view that illustrates a method for manufacturing the capacitor microphone according to the first embodiment of the present invention.

FIG. 5B is a cross-sectional view that illustrates a method for manufacturing the capacitor microphone according to the first embodiment of the present invention.

FIG. 5C is a cross-sectional view that illustrates a method for manufacturing the capacitor microphone according to the first embodiment of the present invention.

FIG. 6A is a cross-sectional view that illustrates a capacitor microphone according to the second embodiment of the present invention and a method for manufacturing the same.

FIG. 6B is a cross-sectional view that illustrates a capacitor microphone according to the second embodiment of the present invention and a method for manufacturing the same.

FIG. 6C is a cross-sectional view that illustrates a capacitor microphone according to the second embodiment of the present invention and a method for manufacturing the same.

FIG. 6D is a cross-sectional view that illustrates a capacitor microphone according to the second embodiment of the present invention and a method for manufacturing the same.

FIG. 7A is a cross-sectional view that illustrates a capacitor microphone according to the third embodiment of the present invention and a method for manufacturing the same.

FIG. 7B is a cross-sectional view that illustrates a capacitor microphone according to the third embodiment of the present invention and a method for manufacturing the same.

FIG. 7C is a cross-sectional view that illustrates a capacitor microphone according to the third embodiment of the present invention and a method for manufacturing the same.

FIG. 7D is a cross-sectional view that illustrates a capacitor microphone according to the third embodiment of the present invention and a method for manufacturing the same.

FIG. 8A is a plain view that illustrates a diaphragm of the capacitor microphone according to the first embodiment of the present invention.

FIG. 8B is a pattern diagram that illustrates a diaphragm of the capacitor microphone according to the first embodiment of the present invention.

FIG. 9A is a circuit diagram that illustrates an equivalent circuit in a diaphragm of the capacitor microphone according to the fourth embodiment of the present invention.

FIG. 9B is a circuit diagram that illustrates an equivalent circuit in a diaphragm of the capacitor microphone according to the fourth embodiment of the present invention.

FIG. 9C is a circuit diagram that illustrates an equivalent circuit in a diaphragm of the capacitor microphone according to the fourth embodiment of the present invention.

FIG. 10A is a cross-sectional view that illustrates a method for manufacturing the capacitor microphone according to the fourth embodiment of the present invention.

FIG. 10B is a cross-sectional view that illustrates a method for manufacturing the capacitor microphone according to the fourth embodiment of the present invention.

FIG. 10C is a cross-sectional view that illustrates a method for manufacturing the capacitor microphone according to the fourth embodiment of the present invention.

FIG. 10D is a cross-sectional view that illustrates a method for manufacturing the capacitor microphone according to the fourth embodiment of the present invention.

FIG. 11A is a cross-sectional view that illustrates a method for manufacturing the capacitor microphone according to the fourth embodiment of the present invention.

FIG. 11B is a cross-sectional view that illustrates a method for manufacturing the capacitor microphone according to the fourth embodiment of the present invention.

FIG. 11C is a cross-sectional view that illustrates a method for manufacturing the capacitor microphone according to the fourth embodiment of the present invention.

FIG. 12A is a cross-sectional view that illustrates a method for manufacturing the capacitor microphone according to the fourth embodiment of the present invention.

FIG. 12B is a cross-sectional view that illustrates a method for manufacturing the capacitor microphone according to the fourth embodiment of the present invention.

FIG. 12C is a cross-sectional view that illustrates a method for manufacturing the capacitor microphone according to the fourth embodiment of the present invention.

### BEST MODE FOR CARRYING OUT THE INVENTION

Embodiments of the present invention will be described below according to the following plural embodiments.

### First Embodiment

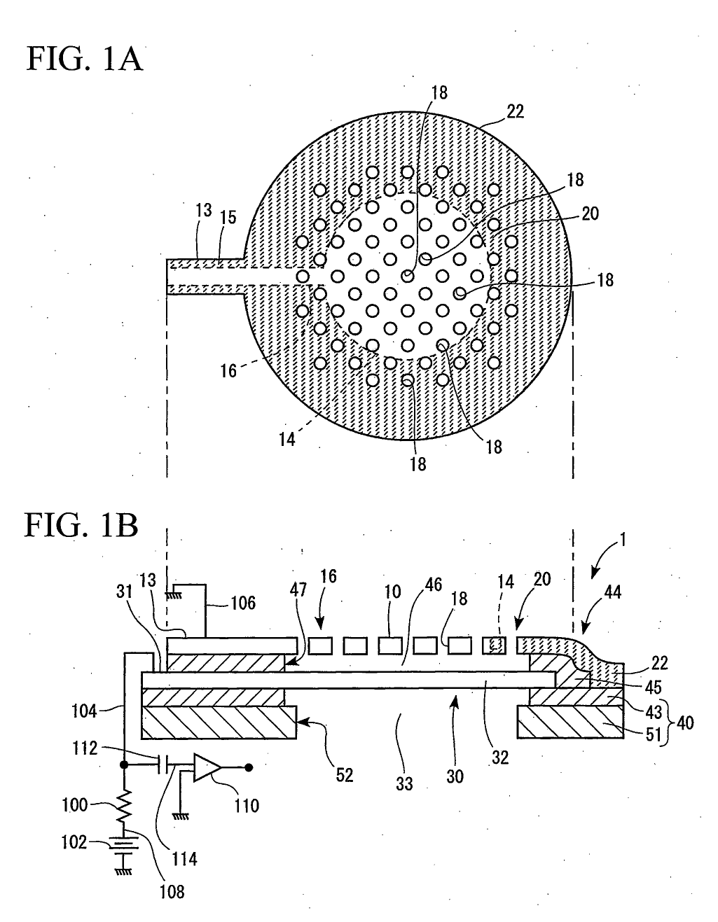

FIG. 1B is a pattern diagram that illustrates a structure of a capacitor microphone 1 according to the first embodiment of the present invention. The capacitor microphone 1 is equipped with a sound perception unit that is illustrated as a cross-sectional view in FIG. 1B, and a detecting unit that is illustrated as a circuit diagram in FIG. 1B.

### [Structure of the Sound Perception Unit]

The edges of a back plate 10 and a diaphragm 30 are fixed at a spacer 44. In other words, the back plate 10 and the diaphragm 30 are mutually supported in parallel to each other in a state that a pressure room 46 is formed between them with the spacer 44. FIG. 1A only illustrates the back plate 10 and its surroundings, and a pad unit 13 of the back plate 10. A shape of the back plate 10 in plain view is not particularly limited. It may be a circular form or any other form. The back plate 10 has a plurality of acoustic holes 18 that penetrate the back plate 10. Sound waves that have passed the acoustic holes 18 of the back plate 10 vibrate the diaphragm 30. Shapes of the acoustic holes 18 in plain view are not particularly limited. They may be a circular form or any other form, as illustrated in FIG. 1A.

The back plate 10 and its pad unit 13 are structured with semiconductor films, such as multicrystal Si, or metal films, such as Ti. The back plate 10 includes a circular form that is not firmly bonded to an insulating film 45 in the semiconductor or metal film 22. The semiconductor or metal film 22 is a single-layered film in which specific resistance is different depending on regions, wherein specific resistance of the nearby edge in the back plate 10 is higher than that of the central unit in the back plate 10. The nearby edge 20 close to the edge fixed on the spacer 44 of the back plate 10 is formed in a high resistance region of the semiconductor or the metal film 22. A disk-shaped central unit 14 of the back plate 10, a linear-shaped connecting unit 16 that extends from the central unit 14 to the pad unit 13, and the pad unit 13 are formed in a low resistance region of the semiconductor or the metal film 22. It is more preferred if a difference of the specific resistance between the nearby edge 20 and the central unit 14 in the back plate 10 becomes larger. An area of the central unit 14 in the back plate 10 is, for example, a value given by trajectory cubic volume of the diaphragm 30 that is vibrating when a sound wave is propagating divided by an amplitude in the center of the diaphragm 30. More specifically, the area of the central unit 14 is, for example, one thirds or half of the area of the diaphragm 30. A shape of the central unit 14 in the diaphragm 30 that lowers specific resistance is, for example, an analog shape of the entire diaphragm 30.

In order to separate the semiconductor or metal film 22 into a high resistance region and a low resistance region, the high resistance region is structured with an amorphous semiconductor or metal, while the low resistance region is structured with a crystalline semiconductor or metal. Otherwise, the high resistance region of the semiconductor or metal film 22 is structured with semiconductors or metal oxidative products or nitrides, while the low resistance region is structured with semiconductors or metals. The location where the semiconductor metal film 22, included in the back plate 10 and its pad unit 13, is used as a semiconductor film, it is preferred to use a semiconductor film in which impurities acting as donors or acceptors are diffused with high concentrations. Structure of the central unit 14 in the back plate 10 with crystalline semiconductor films in which impurities acting as donors and acceptors are diffused with high concentrations can further reduce specific resistance of the central unit 14 in the back plate 10, in comparison with the nearby edge 20 composing of amorphous semiconductors, amorphous metals, semiconductor oxidative products or semiconductor nitrides.

The diaphragm 30 and its pad unit 31 are structured with semiconductor films, such as multicrystal Si, or metal films, such as Ti. The diaphragm 30 includes a circular form that is not firmly bonded to insulating films 34 and 45 in the semiconductor or metal film 32. Where the semiconductor metal film 32, included in the diaphragm 30 and its pad unit 31, is used as a semiconductor film; it is preferred to use a semiconductor film in which impurities acting as donors or acceptors are diffused with high concentrations, and further reduce the specific resistance of the diaphragm 30. The specific resistance of the nearby edge in the diaphragm 30 may be higher than that of the central unit by using the semiconductor or metal film 32 structuring the diaphragm 30 with different specific resistance depending on regions the same as the back plate 10. If the specific resistance of the nearby edge in either the diaphragm 30 or the back plate 10 is higher than that of the central unit, however, the sensitivity of the capacitor microphone is improved even though the specific resistance of the other is uniformed. In other words, the same results can be obtained using a semiconductor or metal film 32 structured with the diaphragm 30 with different specific resistance depending on regions and the entire uniformed specific resistance of the back plate 10. Furthermore, a manufacturing process for the capacitor microphone 1 can be simplified by means of using either the diaphragm 30 or the back plate only as a semiconductor or metal film of which specific resistance in the nearby edge is higher than that of the central unit, resulting in requiring no lithography step, ion-implanting step, and annealing step, which are necessary for limiting the high resistance regions.

A spacer 44 is structured with an insulating film 45 that is adapted to a side wall surface 47 of the pressure room 46; and an external part from the side wall surface 47 of the pressure room 46 on the semiconductor or metal films 22 and 32.

A base 40, which has a pressure buffering room 33 supporting the diaphragm 30, is structured with the insulating film 43 in which the semiconductor or metal film 32 adapted to the diaphragm 30 is fixed, and a base film 51. Larger cubic capacity in the pressure buffering room 33 allows the vibration of the diaphragm 30 to be hardly inhibited by an internal pressure of the pressure buffering 33 when sound waves are propagated to the diaphragm 30, in a state that the pressure buffering room 33 is kept sealed.

The diaphragm 30 may be positioned closer to a sound source than the back plate 10, so that sound waves are directly propagated to the diaphragm 30. In this case, the acoustic hole 18 functions as an air passage communicating with the pressure room 46, formed between the back plate 10 and the diaphragm 30, and with its external space.

### [Structure of the Detecting Unit]

The pad unit 31 on the diaphragm 30 is connected with lead line 104 that is connected to one edge of a resister 100. The pad unit 13 on the back plate 10 is connected to a lead line 106 that is connected to a ground of a substrate in which the capacitor microphone 1 is mounted. The other edge of a resister 100 is connected with a lead line 108 that is connected with an output edge of a bias power circuit 102. A resister with large resistance value is used as the resister 100. More specifically, it is preferred to use the resister 100 having a GΩ order of an electric resistance. An input edge of a preamplifier 110 is connected with a lead line 114 that is connected with one edge of a capacitor 112. The lead line 104 that connects the diaphragm 30 and the resister 100 is also connected with other edges of the capacitor 112.

### [Operation of the Capacitor Microphone]

When sound waves are propagated to the diaphragm 30 penetrating the acoustic holes 18 of the back plate 10, the sound waves vibrate the diaphragm 30. When the diaphragm 30 vibrates, its vibration changes a distance between the back plate 10 and the diaphragm 30, and also changes capacitance of the capacitor that is adapted to the diaphragm 30 and the back plate 10.

Since the diaphragm 30 is connected via its pad unit 31 to the resister 100 of which resistance value is large, electrical charges accumulated in the capacitor rarely flow through the resister 100 even though the capacitance of the capacitor is changed by the vibration of the diaphragm 30, as described above. In other words, the electrical charges accumulated in the capacitor formed by the diaphragm 30 and the back plate 10 can be deemed to remain unchanged. Changes in capacitance of the capacitor may be accordingly extracted as a change in voltage between the diaphragm 30 and the back plate 10.

The capacitor microphone 1 outputs extremely little change in capacitance of the capacitor as electric signals by means of using the preamplifier 110 that amplifies changes in voltage for the ground of the diaphragm 30. More specifically, the capacitor microphone 1 converts changes in sound pressure applied to the diaphragm 30 into changes in capacitance of the capacitor, then converts the changes in capacitance of the capacitor into changes in voltage, so that electric signals correlating changes in sound pressure are output.

The diaphragm 30 vibrates with its edge as the fixed edge. Therefore, the center farthest from the edge of the diaphragm vibrates with the largest amplification. Compared with this, a nearby edge 20 close to the edge fixed at the spacer 33 of the diaphragm 30 amplifies less.

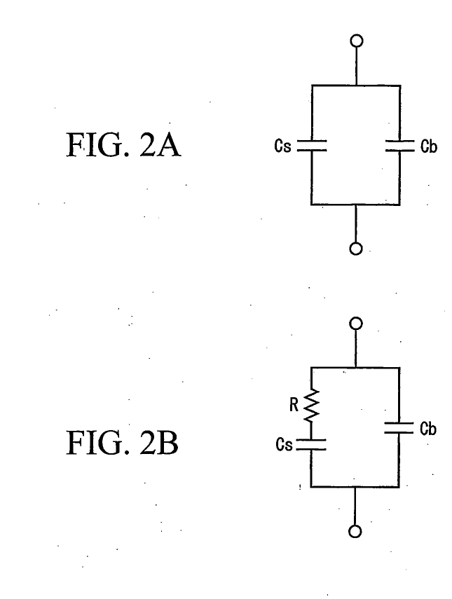

Meanwhile, FIG. 2A illustrates an equivalent circuit of the capacitor microphone equipped with a thin-film electrode having the uniform conductivity; the equivalent circuit includes the nearby edge of the diaphragm, assuming it does not completely vibrate, capacity Cs formed by the back plate, the central unit of the diaphragm, assuming it vibrates with some amplification to maintain a flat shape, and capacity Cb formed by the back plate connected together in parallel. When it is considered that the diaphragm 30 is structured with the central unit, which vibrates with some amplification to maintain a flat shape, and the nearby edge, which does not completely vibrate, and electric charges move between the nearby edge and the central unit along with vibration of the diaphragm 30, electrical potentials of the nearby edge in the diaphragm for the nearby edge of the back plate 10 changes and the electrical potential fluctuation range of the diaphragm for the central unit of the back plate 10 becomes small. The electrical potential change of the nearby edge in the diaphragm 30 for the nearby edge of the back plate 10 is a noise component of output signals from the capacitor microphone 1, while the electrical potential change of the central unit in the diaphragm for the central unit of the back plate 10 is a true signal component of output signals from the capacitor microphone 1.

The capacitor microphone 1, according to the present embodiment, has high specific resistance of the nearby edge 20 close to the edge fixed at the spacer 44 of the back plate 10 in comparison with that of the central unit 14. Therefore, an equivalent circuit of the capacitor microphone 1, as illustrated in FIG. 2B, includes the nearby edge of the diaphragm 30, assuming it does not completely vibrate, capacity Cs formed by the back plate 10, the central unit of the diaphragm 30, assuming it vibrates with some amplification to maintain a flat shape, and capacity Cb formed by the back plate connected with large internal resistance R among them. Since the internal resistance R blocks movements of the electrical potentials caused between capacity Cs and capacity Cb along with the vibration of the diaphragm 30, electrical changes of the nearby edge in the diaphragm 30 for the nearby edge 20 of the back plate 10 are inhibited. The capacitor microphone 1, according to the present embodiment, therefore, has high sensitivity in comparison with capacitor microphones equipped with thin film electrodes having the uniform conductivity.

### [Manufacturing Method]

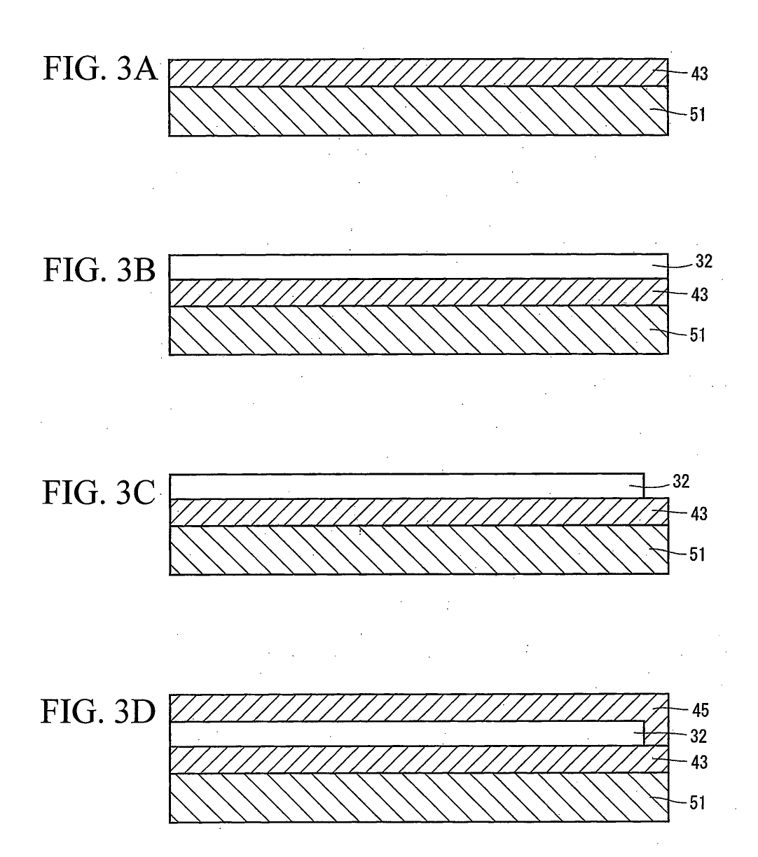

FIGS. 3A to 5C are cross-sectional views that illustrate a method for manufacturing the capacitor microphone 1 according to the first embodiment.

First, a base film 51 and an insulating film 43 are formed, as illustrated in FIG. 3A. More specifically, for example, SiO₂ is accumulated on a surface of a single crystal silicone substrate as the base film 51 by a chemical vapor deposition (CVD) method. Although the insulating film 43 may be formed by thermal oxidation of the single crystal silicone substrate, it is preferred to accumulate SiO₂ by the CVD method since etching rates for an insulating film 45, as described below, and the insulating film 43 both made of SiO₂ become the same.

Next, a semiconductor or metal film 32 is formed on the insulating film 43, as illustrated in FIG. 3B. The semiconductor or metal film 32 structures the diaphragm 30 and its pad unit 31. In case of forming the semiconductor film 32, Si, for example, is accumulated on the insulating film 43 by a low pressure chemical vapor deposition (LPCVD) method. The accumulated Si film is doped by ion-implanted in high concentrations with impurities as donors or acceptors, thereafter the Si film may be activated by annealing. The impurities acting as donors or acceptors may be doped to Si by in situ when Si is accumulated on the insulating film 43 by the LPCVD method. In case of forming the semiconductor film 32, Ti, for example, is accumulated on the insulating film 43 by a spatter.

Next, the semiconductor or metal film 32 is patterned into a desired shape, as illustrated in FIG. 3C. More specifically, a mask is first formed on the film 32 with lithography; thereafter, the film 32 is etched with a compound liquid of HNO₃ with HF, and HF to remove the mask.

Next, the insulating film 45 structuring the spacer 44 is formed on the semiconductor or metal film 32, as illustrated in FIG. 3D. More specifically, SiO₂, for example, is accumulated on the film 32 by the CVD method.

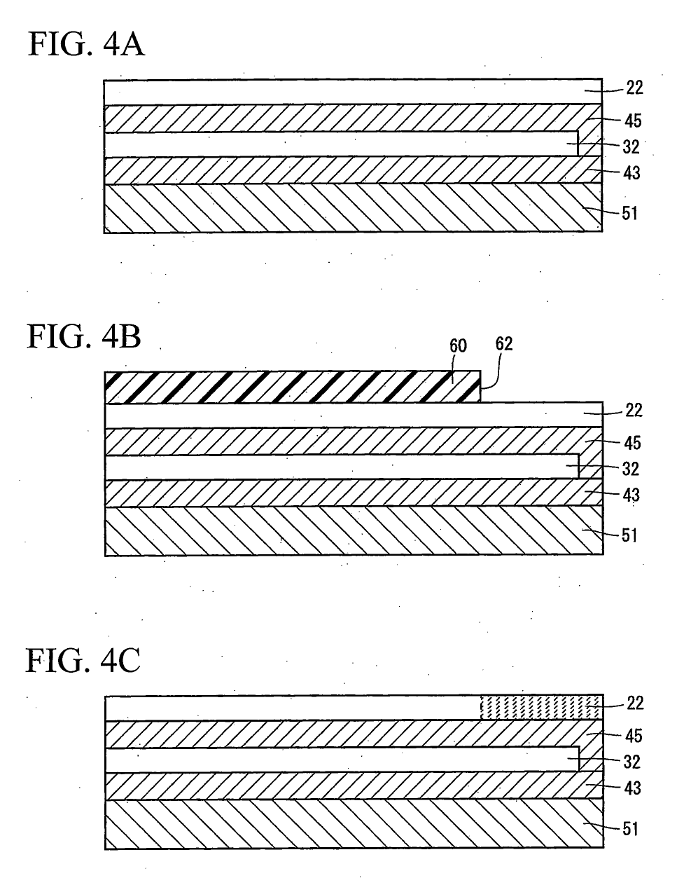

Next, a semiconductor or metal film 22 is formed on the insulating film 45, as illustrated in FIG. 4A. The semiconductor or metal film 22 structures the back plate 10 and its pad unit 13. In case of forming the semiconductor film 22, Si, for example, is accumulated on the insulating film 45 by a low pressure chemical vapor deposition (LPCVD) method. The accumulated Si film is doped by ion-implanted in high concentrations with impurities as donors or acceptors, thereafter the Si film may be activated by annealing. The impurities acting as donors or acceptors may be doped to Si by in situ when Si is accumulated on the insulating film 45 by the LPCVD method. In case of forming the semiconductor film 22, Ti, for example, is accumulated on the insulating film 45 by a spatter.

Next, a mask 60 composing of predetermined patterns, such as a light-sensitive film, is formed on a film 22 with lithography, as illustrated in FIG. 4B. The mask 60 is a mask for ion-implanting, and it has an opening 62 that supports a nearby edge 20 of the back plate 10 and a nearby edge 15 of the pad unit 13. Doping impurities by means of ion-implanting allows amount, depth and distribution of the impurities within the semiconductor or metal film 22 to be accurately controlled, so that a process can be proceeded in low temperatures. The impurities may be doped into the film 22 by diffusion using Si₃N₄ film as the mask 60. O and N may be doped into the semiconductor or metal film 22 by plasma polymerization, using oxygen plasma and nitriding plasma.

Next, the semiconductor or metal film 22 is ion-implanted with impurities to remove the mask 60, as illustrated in FIG. 4C. The impurities include Ar, O, N, and P. Ion-implanting with the impurities into a part of the semiconductor or metal 22 allows the doped region on the impurities of the film 22 to be amorphous, so that its specific resistance can be increased. In case of ion-implanting with O and N into a part of the semiconductor or metal film 22, the ion-implanted film 22 may be annealed. Since annealing the film 22 partly ion-implanted with O and N chemically activates semiconductors or metals structuring the film 22 that react, high resistant or an insulating oxidized region or nitride region can be formed on the film 22.

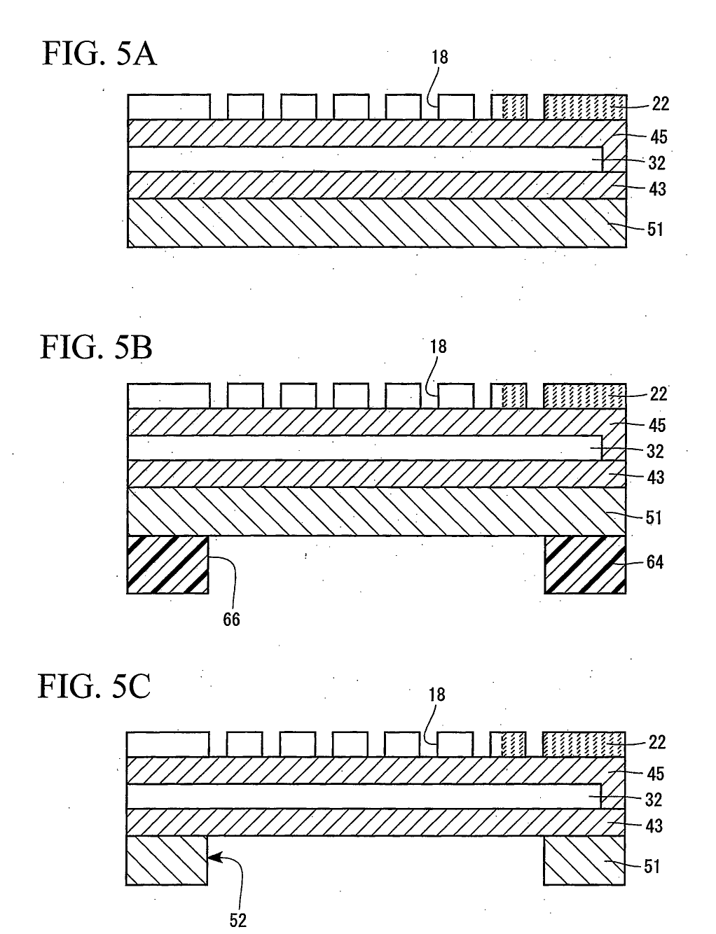

Next, the semiconductor or metal film 22 is patterned into a desired shape, as illustrated in FIG. 5A, and an acoustic hole 18 is formed on the film 22. More specifically, a mask is first formed on the film 22 with lithography; thereafter the film 22 is etched with a compound liquid of HNO₃ with HF, and HF to remove the mask.

Next, a mask 64 with predetermined patterns is formed on a base film 51 with lithography, as illustrated in FIG. 5B. The mask 64 is an etching mask for forming a part of a pressure buffering room 33 of the base 40, and it has an opening 66 at a site that supports the pressure buffering room 33.

Next, a side wall surface 52 of the pressure buffering room 33 is formed in the base film 51 by removing the sites exposed in the opening 66 of the base film 51 with Deep RIE used; thereafter, the mask 64 is removed, as illustrated in FIG. 5C.

Next, when the insulating film 43 and the insulating 45 are etched with BHF used by masking the base film 51 and the semiconductor or metal film 22, the sound perception unit of the capacitor microphone 1, illustrated in FIG. 1, is obtained. Remaining parts of the pressure buffering room 33 and the pressure room 44 are formed by etching liquid that reaches to the insulating films 43 and 45 from the pressure buffering room 33 formed on the base film 51 and the acoustic hole formed on the film 22, then the insulating films 43 and 45 are etched.

As described above, using a well-understood manufacturing process for semiconductor devices, including the step of ion-implanting with impurities to a part of the semiconductor or metal film 22, or the steps of ion-implanting with impurities to a part of the semiconductor or metal film 22; thereafter, annealing the film 22, allows the back plate 10 to be formed on the semiconductor or metal film 22 of which specific resistance is different depending on the regions. Capacitor microphones with simple structure and high sensitivity, therefore, can be manufactured with low costs. Particularly ion-implanting with impurities to the part of the semiconductor or metal film 22 reduces thermal processing steps, according to a method for forming the back plate 10 by using semiconductor or metal film 22, which is partly amorphous, so that thermal damages to the thin films and diffusion of unnecessary impurities can be inhibited. Manufacturing costs for capacitor microphones, therefore, can be further reduced.

### Second Embodiment

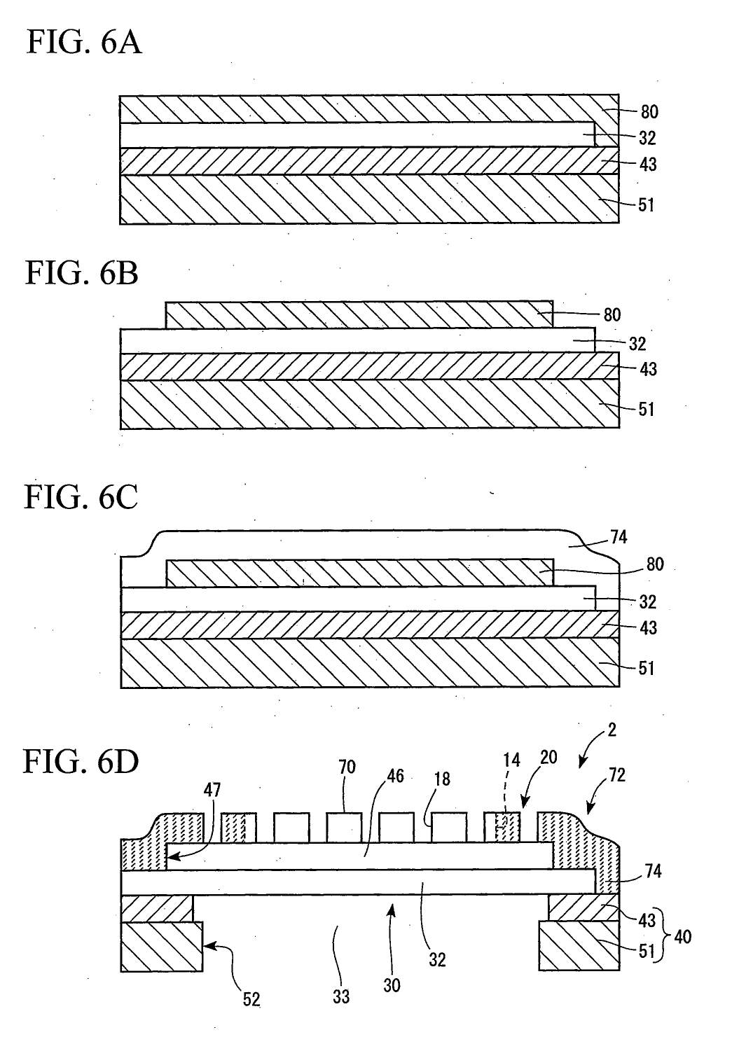

FIG. 6 includes a plurality of cross-sectional views that illustrate a capacitor microphone 2 according to the second embodiment of the present invention and a method for manufacturing the same.

As FIG. 6D illustrates, the capacitor microphone 2 according to the second embodiment includes no insulating film between the film 74 that structures the back plate 70 and the film 32 that structures the diaphragm 30. The diaphragm 30 and the back plate 70 can be supported in an insulating state or close to the state by the high resistance region of the semiconductor or metal film 74. Insulating the high resistance region of the semiconductor or metal film 74 allows the sensitivity of the capacitor microphone 2 to be more improved. Since no insulating films are present between the film 74 that structures the back plate 70 and the film 32 that structures the diaphragm 30, conductive films are needed on the film 74. The conductive films are wired at the central unit 14 of the back plate 70.

A method for manufacturing the capacitor microphone 2 starts from the steps, as illustrated in FIGS. 3A to 3C.

Next, a cover film 80 is formed on the semiconductor or metal film 32, as illustrated in FIG. 6A.

Next, the cover film 80 is patterned into a desired shape, as illustrated in FIG. 6B. More specifically, a mask is first formed on the cover film 80 with lithography; thereafter, the cover film 80 is etched, and then removes the mask.

Next, the semiconductor or metal film 74 is formed on the semiconductor or metal film 32 as if the cover film 80 is covered, as illustrated in FIG. 6C. A specific method for forming the film 74 is according to the method for forming the film 22 (refer to FIG. 4A).

Next, a high resistance region is formed on the semiconductor or metal film 74 according to the reforming step of the semiconductor or metal film 22 (refer to FIGS. 4B and 4C).

Next, the semiconductor or metal film 74 is patterned according to the patterning step of the semiconductor or metal film 22 (refer to FIG. 5A).

Next, a part of the pressure buffering room 33 is formed on the base film 51 by means of etching the base film 51 (refer to FIGS. 5B and 5C).

Next, etching the cover film 80 with the semiconductor or metal film 74 as a mask and etching the insulating film 43 by BHF with the base film 51 as a mask can provide the capacitor microphone 2, as illustrated in FIG. 6D.

As described above, the structure of the capacitor microphone 2 and its manufacturing steps can be simplified by integrally forming the back plate 70 and a part of the spacer 72 in comparison with those of the conventional capacitor microphones in which electrodes are fixed at the central unit of the insulating films. Manufacturing costs for capacitor microphone 2, therefore, can be reduced.

### Third Embodiment

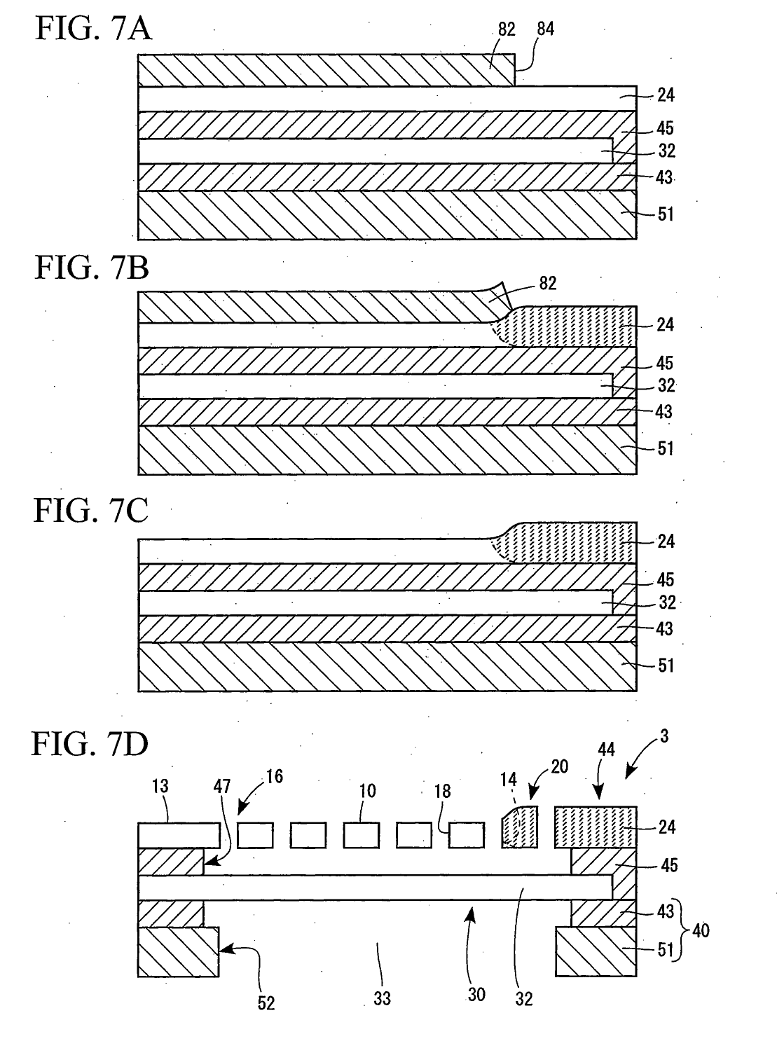

FIG. 7 includes a plurality of cross-sectional views that illustrate a capacitor microphone 3 according to the third embodiment of the present invention and a method for manufacturing the same.

As FIG. 7D illustrates, the capacitor microphone 3 according to the third embodiment includes a high resistance region structuring the back plate 10 is thick in comparison with a low resistance region. Thick high resistance region structuring the nearby edge 20 of the back plate 10 on the semiconductor or metal film 24 includes semiconductors or metal oxidative products or nitride products.

A method for manufacturing the capacitor microphone 3 starts from the steps of forming a semiconductor or metal film 24, as illustrated in FIGS. 3A to 4A.

Next, a mask 82, which has an opening 84 that supports the nearby edge 20 and the pad unit 13 of the back plate 10, is formed on the semiconductor or metal film 24. More specifically, Si₃N₄ is, for example, first accumulated on the entire semiconductor or metal film 24 by the CVD method. Next, the mask 82 is obtained by means of forming predetermined patterned light-sensitive films with lithography on the accumulated Si₃N₄ film, using H₃PO₄ for etching the Si₃N₄ film, and then removing the light-sensitive films.

Next, sites exposed from the opening 84 of the semiconductor or metal film 24 are selectively oxidized or oxynitrided, as illustrated in FIG. 7B. More specifically, the film 24 is, for example, oxidized by thermal oxidation. The film 24 can be also oxynitrided by using gases including NH₃ at the time of the thermal oxidation. In case where the film 24 is composed of Si, it is preferred to oxynitride the film 24 composed of Si because etching the film 24 at the etching step for the insulating films 45 and 43 composed of SiO₂, as described below, is inhibited. The region in which the semiconductor or metal film 24 is oxidized or oxynitrided expands the volume and it becomes thicker than the region of the semiconductor or metal.

Next, a mask 82 is removed, as illustrated in FIG. 7C. The mask 82 is etched, for example, by using H₃PO₄.

Next, the semiconductor or metal film 22 is patterned into a desired shape, and an acoustic hole 18 is formed on the film 24. The acoustic hole 18 is formed, for example, by means of forming light-sensitive films having desired patterns on the film 24, and etching. Etching is carried out, for example, by the steps of using the light-sensitive film on the film 24 as a mask, etching the oxidized or oxynitrided region of the film 24 using fluorine based etching gas, and forming the acoustic hole 18 in the oxidized or oxynitrided region; next, etching the semiconductor or metal region of the film 24 using chloride based etching gas, and forming the acoustic hole 18 in the semiconductor or metal region.

Next, a part of the pressure buffering room 33 is formed on the base film 51 by means of etching the base film 51 (refer to FIGS. 5B and 5C).

Next, when the insulating film 43 and the insulating 45 are etched with BHF used by masking the base film 51 and the semiconductor or metal film 24, the capacitor microphone 3, illustrated in FIG. 7D, is obtained.

Implementation examples of a mode for carrying out the present invention are further described below according to the plural embodiments.

### Fourth Embodiment

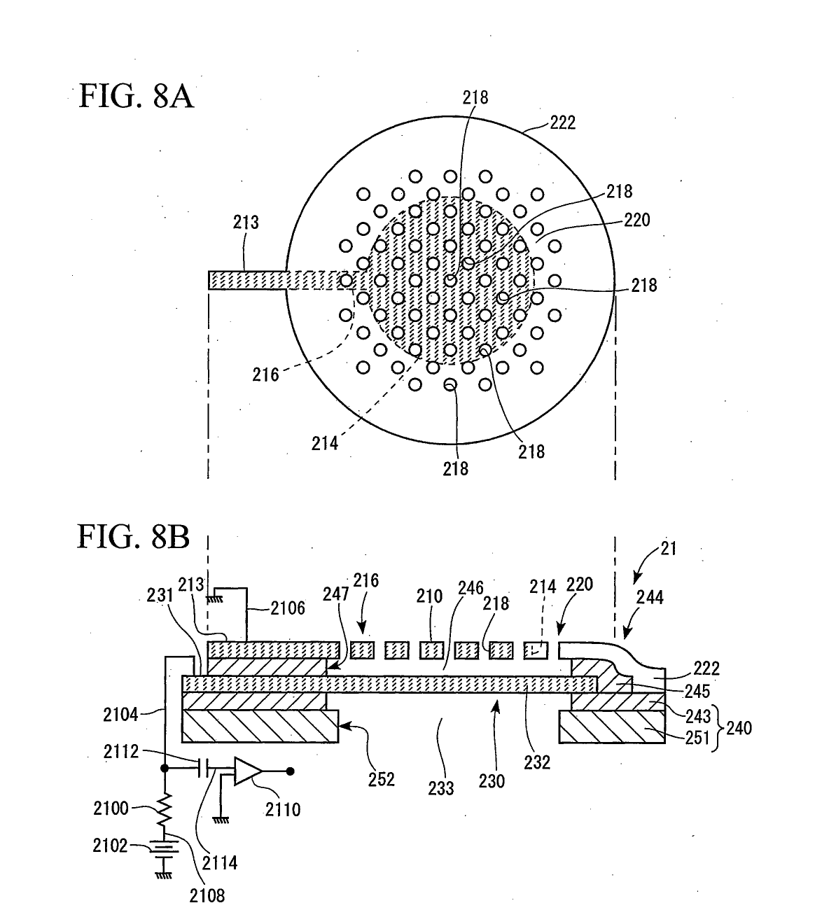

FIGS. 8A and 8B are pattern diagrams that illustrate a structure of a capacitor microphone 21 according to the first embodiment of the present invention. The capacitor microphone 21 is equipped with a sound perception unit that is illustrated as a cross-sectional view in FIG. 8B, and a detecting unit that is illustrated as a circuit diagram in FIG. 8B.

### [Structure of the Sound Perception Unit]

Edges of a back plate 210 and a diaphragm 230 are respectively fixed at a spacer 444. In other words, the back plate 210 and the diaphragm 230 are mutually supported in parallel to each other in a state that a pressure room 246 is formed between them with the spacer 244. FIG. 8A only illustrates the back plate 210 and its surroundings, and a pad unit 213 of the back plate 210. A shape of the back plate 210 and its surroundings in plain view are not particularly limited. It may be a circular form, as illustrated in FIG. 8, or any other form. The back plate 210 has a plurality of acoustic holes 218 as through-holes that penetrate the back plate 210. Shapes of the acoustic holes 218 in plain view are not particularly limited. They may be a circular form, as illustrated in FIG. 8A, or any other form.

The back plate 210 and its pad unit 213 are structured with semiconductor film 222, such as multicrystal Si. The back plate 210 includes a circular form that is not firmly bonded to an insulating film 245 in the semiconductor film 222. In regions that support a disk-shaped central unit 214 of the back plate 210, a linear-shaped connecting unit 216 that extends from the central unit 214 to the pad unit 213 and the pad unit 213 on the semiconductor film 222, impurities acting as donors or acceptors are diffused with higher concentrations than in the remaining regions. An area of the central unit 214 is, for example, a value given by trajectory cubic volume of the diaphragm 230 that is vibrating when a sound wave is propagating divided by amplitude in the center of the diaphragm 230. More specifically, the area of the central unit 214 is, for example, one thirds or half of the area of the diaphragm 230. An outer shape of the central unit 214 is, for example, a disk analogous to an outer shape of the diaphragm 230. The impurities acting as donors include, for example, P, As, and Sb. The impurities acting as acceptors include, for example, B. Since no impurities acting as donors or acceptors are diffused in the nearby edge 220 of the back plate 210 close to edges fixed at the spacer 244, its specific resistance is higher than that in the central unit 214. The impurities acting as donors or acceptors may be diffused in the nearby edge 220 of the back plate 210 with concentrations lower than that of the central unit 214. For example, the order of the impurity concentration in the central unit 214 is 10²⁰/cm³, the impurity concentration at the nearby edge 220 is between 10¹⁶ and 10¹⁷/cm³.

The diaphragm 230 and its pad unit 231 are structured with semiconductor film 232, such as multicrystal Si. The diaphragm 230 includes a circular form that is not firmly bonded to insulating films 234 and 245 in the semiconductor or metal film 232. Impurities acting as donors or acceptors are diffused with high concentrations across the semiconductor film 232 that structures the diaphragm 230 and its pad unit 231. The impurities may be similar to or different from the impurities diffused on the semiconductor film 222 that constructs the back plate 210. A conductive type in the region where the impurities acting as donors or acceptors for the semiconductor film 222 are diffused with high concentrations may be similar to or different from the conductive type of the semiconductor film 232. The specific resistance of the nearby edge unit in the diaphragm 230 may be higher than that of the central unit by limiting the region of diffused impurities on the semiconductor film 232 structuring the diaphragm 230, similar to the back plate 210. If the specific resistance of the nearby edge unit in either the diaphragm 230 or the back plate 210 is higher than that of the central unit, however, the sensitivity of the capacitor microphone 21 is improved even though the specific resistance of the other is uniformed. In other words, the similar effects can be obtained even in case of limiting the region of diffused impurities on the semiconductor film 232 that structures the diaphragm 230 and diffusing the impurities across the semiconductor film 222 that structures the back plate 210. Furthermore, a manufacturing process for the capacitor microphone 21 can be simplified by means of using either the diaphragm 230 or the back plate 210 only as a semiconductor film resulting in requiring no lithography step for a mask and the step of removing the mask, which are necessary for limiting the region of diffused impurities.

A spacer 244 is structured with an insulating film 245 that is adapted to a side wall surface 247 of the pressure room 246; and an external part from the side wall surface 247 of the pressure room 246 on the semiconductor films 222 and 232.

Edges of the back plate 240 are fixed at the diaphragm 230. Sound waves that have passed the acoustic holes 218 of the back plate 210 vibrate the diaphragm 230. A base 240, which has a pressure buffering room 233 supporting the diaphragm 230, is structured with the insulating film 243, in which the semiconductor film 232 structuring the diaphragm 230 is fixed, and a base film 251, which is mounted at an inverted semiconductor film 232 of the insulating film 243 forming a side wall surface 252 of the pressure buffering room 233. Larger cubic capacity in the pressure buffering room 233 allows the vibration of the diaphragm 230 to be hardly inhibited by an internal pressure of the pressure buffering 33 when sound waves are propagated to the diaphragm 230 in a state that the pressure buffering room 233 is kept sealed.

The diaphragm 230 may be positioned closer to a sound source than the back plate 210, so that sound waves are directly propagated to the diaphragm 230. In this case, the acoustic hole 218 functions as an air passage communicating with the pressure room 246 formed between the back plate 210 and the diaphragm 230, and with its external space.

### [Structure of the Detecting Unit]

The pad unit 231 on the diaphragm 230 is connected with lead line 2104 that is connected to one edge of a resister 2100. The pad unit 213 on the back plate 210 is connected to a lead line 2106 that is connected to a ground of a substrate in which the capacitor microphone 21 is mounted. Other edge of a resister 2100 is connected with a lead line 2108 that is connected with an output edge of a bias power circuit 2102. A resister with large resistance value is used as the resister 2100. More specifically, it is preferred to use the resister 2100 having a GΩ order of an electric resistance. An input edge of a preamplifier 2110 is connected with a lead line 2114 that is connected with one edge of a capacitor 2112. The lead line 2104 that connects the diaphragm 230 and the resister 2100 is also connected with other edges of the capacitor 2112.

### [Operation of the Capacitor Microphone]

Sound waves that have passed the acoustic holes 218 of the back plate 210 vibrate the diaphragm 230. When the diaphragm 230 vibrates, its vibration changes a distance between the back plate 210 and the diaphragm 230, and also changes capacitance of the capacitor that is adapted to the diaphragm 230 and the back plate 210.

Since the diaphragm 230 is connected via its pad unit 231 to the resister 2100 of which the resistance value is large, electrical charges accumulated in the capacitor rarely flow through the resister 2100 even though the capacitance of the capacitor is changed by the vibration of the diaphragm 230, as described above. In other words, the electrical charges accumulated in the capacitor formed by the diaphragm 230 and the back plate 210 can be deemed to remain unchanged. Changes in capacitance of the capacitor may be accordingly extracted as a change in voltage between the diaphragm 230 and the back plate 210.

The capacitor microphone 21 outputs extremely little change in capacitance of the capacitor as electric signals by means of using the preamplifier 2110 that amplifies changes in voltage for the ground of the diaphragm 230. More specifically, the capacitor microphone 21 converts changes in sound pressure applied to the diaphragm 230 into changes in capacitance of the capacitor, then converts the changes in capacitance of the capacitor into changes in voltage, so that electric signals correlating changes in sound pressure are output.

The diaphragm 230 vibrates with its edge as the fixed edge. In other words, the center farthest from the edge of the diaphragm vibrates with the largest amplification. Compared with this, a nearby edge 220 close to the edge fixed at the spacer 244 of the diaphragm 230 amplifies less.

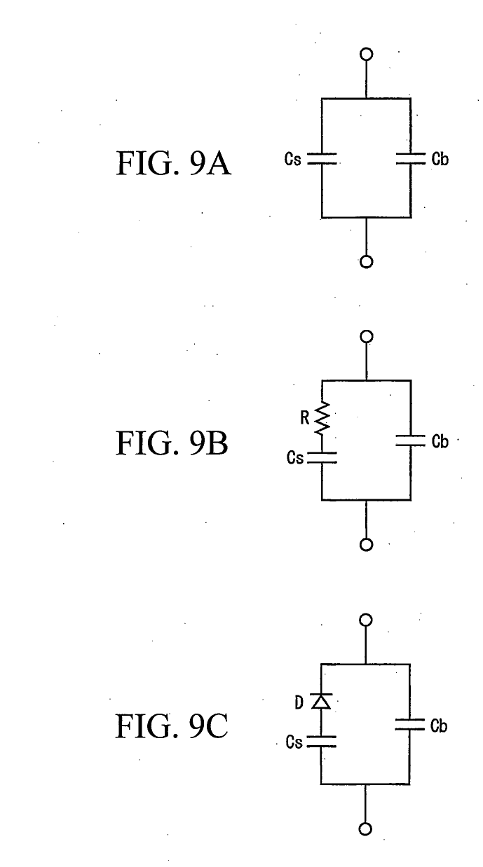

Meanwhile, FIG. 9A illustrates an equivalent circuit of the capacitor microphone equipped with a thin-film electrode having the uniform conductivity; the equivalent circuit includes the nearby edge of the diaphragm assuming it does not completely vibrate, capacity Cs formed by the back plate, the central unit of the diaphragm assuming it vibrates with some amplification to maintain a flat shape, and capacity Cb formed in the central unit of the diaphragm connected together in parallel. When it is considered that the diaphragm 230 is structured with the central unit, which vibrates with some amplification to maintain a flat shape, and the nearby edge, which does not completely vibrate, and electrical charges move between the nearby edge and the central unit along with vibration of the diaphragm 230, electrical potentials of the nearby edge in the diaphragm for the nearby edge of the back plate 210 change and the electrical potential fluctuation range of the diaphragm for the central unit of the back plate 210 becomes small. The electrical potential change of the nearby edge in the diaphragm 230 for the nearby edge of the back plate 210 is a noise component of output signals from the capacitor microphone 21, while the electrical potential change of the central unit in the diaphragm for the central unit of the back plate 210 is a true signal component of output signals from the capacitor microphone 21.

The capacitor microphone 1 according to the present embodiment has high specific resistance at the nearby edge 220 in comparison with that of the central unit 214 because the impurities acting as donors or acceptors are not diffusing in the nearby edge 220 close to the edge fixed at the spacer 244 of the back plate 210. Therefore, an equivalent circuit of the capacitor microphone 21, as illustrated in FIG. 9B, includes the nearby edge of the diaphragm 230 assuming it does not completely vibrate, capacity Cs formed by the back plate 210, the central unit of the diaphragm 230 assuming it vibrates with some amplification to maintain a flat shape, and capacity Cb formed by the back plate connected with large internal resistance R among them. Since the internal resistance R blocks movements of the electrical potentials caused between capacity Cs and capacity Cb along with the vibration of the diaphragm 230, electrical changes of the nearby edge in the diaphragm 230 for the nearby edge 220 of the back plate 210 are inhibited. The capacitor microphone 21 according to the present embodiment, therefore, has high sensitivity in comparison with capacitor microphones equipped with thin film electrodes having the uniform conductivity.

### [Manufacturing Method]

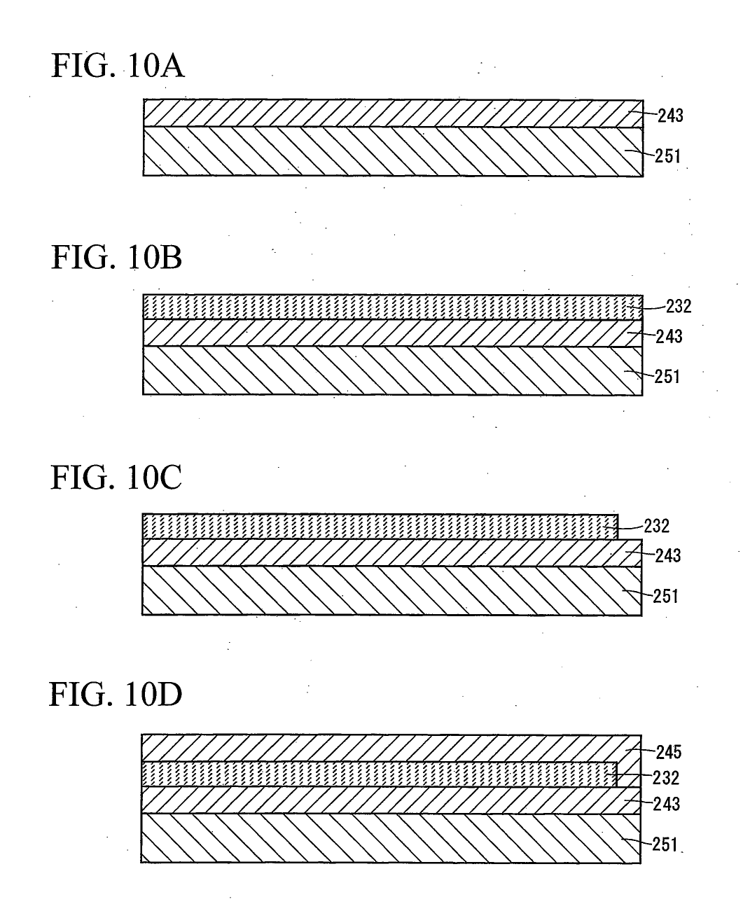

FIGS. 10A to 12C are cross-sectional views that illustrate a method for manufacturing capacitor microphone 21 according to the fourth embodiment of the present invention.

First, a base film 251 and an insulating film 243 are formed, as illustrated in FIG. 10A. More specifically, for example, SiO₂ is accumulated on a surface of a single crystal silicone substrate as the base film 251 by a chemical vapor deposition (CVD) method. Although the insulating film 243 may be formed by thermal oxidation of the single crystal silicone substrate, it is preferred to accumulate SiO₂ by the CVD method since etching rates for an insulating film 245, as described below and the insulating film 243 both made of SiO₂ become the same.

Next, a semiconductor film 232 is formed on the insulating film 243, as illustrated in FIG. 10B. The semiconductor or metal film 232 structures the diaphragm 230 and its pad unit 231. More specifically, for example, after Si is accumulated on the insulating film 243 by the LPCVD method, the accumulated Si film is doped by ion-implanted in high concentrations with impurities as donors or acceptors, then the Si film is activated by annealing and forms the semiconductor film 232. The impurities acting as donors or acceptors may be doped to Si by in situ when Si is accumulated on the insulating film 243 by the LPCVD method.

Next, the semiconductor film 232 is patterned into a desired shape, as illustrated in FIG. 10C. More specifically, a mask is first formed on the semiconductor film 232 with lithography; thereafter, the semiconductor film 232 is etched with a compound liquid of Cl₂ and O₂ and removes the mask.

Next, the insulating film 245 structuring the spacer 244 is formed on the semiconductor film 232, as illustrated in FIG. 10D. More specifically, SiO₂, for example, is accumulated on the semiconductor film 232 by the CVD method.

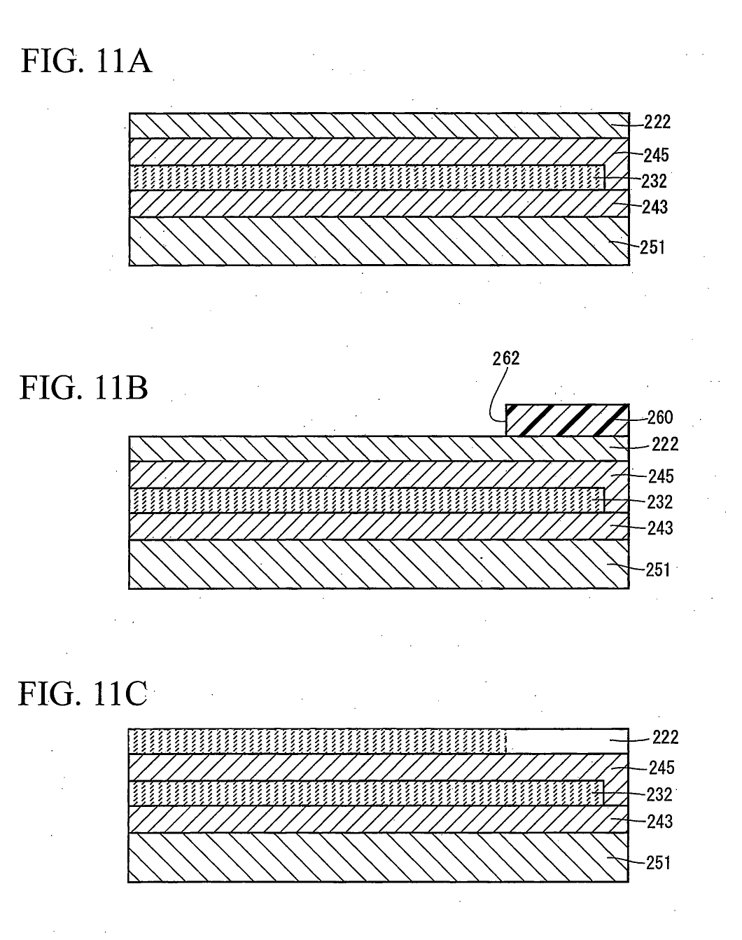

Next, a semiconductor film 222 is formed on the insulating film 245, as illustrated in FIG. 11A. The semiconductor film 222 structures the back plate 210 and its pad unit 213. More specifically, SiO₂, for example, is accumulated on the insulating film 245 by the CVD method.

Next, a mask 260 composing of predetermined patterns, such as a light-sensitive film, is formed on a semiconductor film 222 with lithography, as illustrated in FIG. 11B. The mask 260 is a mask for ion-implanting, and it has an opening 262 that supports a central unit 214 of the back plate 210, connecting unit 216 and a pad unit 213. Doping impurities by means of ion-implanting allows amount, depth and distribution of the impurities within the semiconductor 222 to be accurately controlled so that a process can be proceeded in low temperatures. The impurities may be doped to the semiconductor film 222 by diffusion. In such case, Si₃N₄ is used for the mask 260.

Next, the impurities acting as donors or acceptors are doped to the semiconductor film 222 by ion-implanting with high concentration, as illustrated in FIG. 11C, and the mask 260 is removed, activating the semiconductor film 222 with annealing.

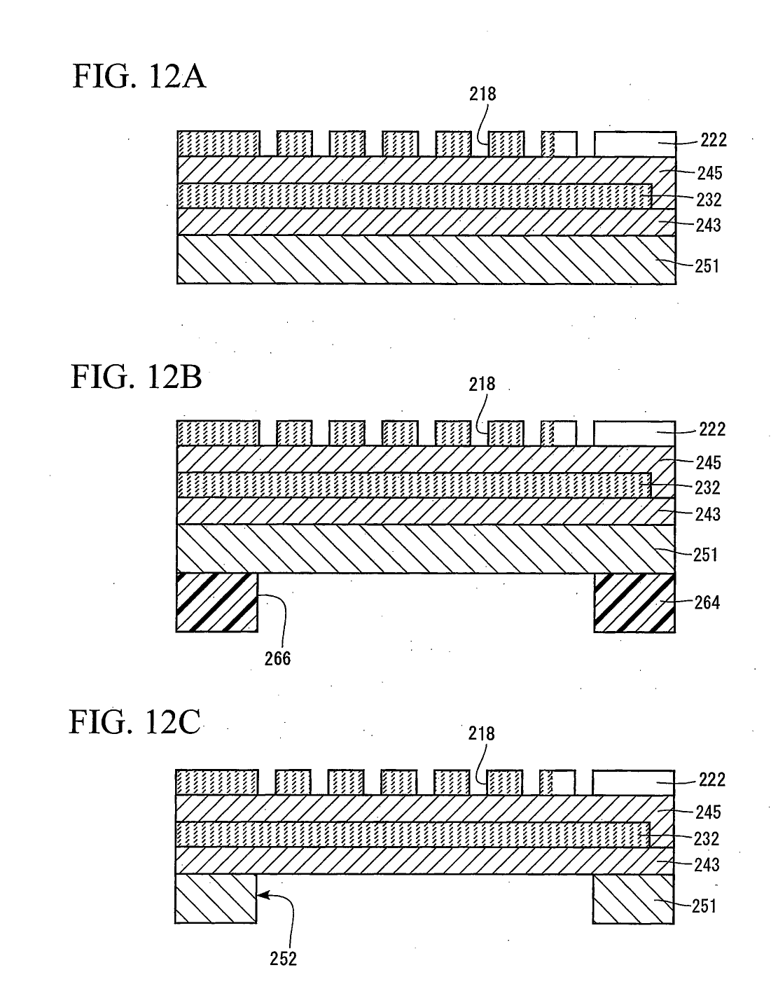

Next, the semiconductor film 222 is patterned into a desired shape, as illustrated in FIG. 12A, and an acoustic hole 18 is formed on the semiconductor film 222. More specifically, a mask is first formed on the semiconductor film 222 with lithography; thereafter, the semiconductor film 222 is etched with compound gases of Cl₂ and O₂, and removes the mask.

Next, a mask 264 with predetermined patterns is formed on a surface of the base film 251 with lithography, as illustrated in FIG. 12B. The mask 264 is an etching mask for forming a part of a pressure buffering room 233 of the base 240, and it has an opening 266 at a site that supports the pressure buffering room 233.

Next, a side wall surface 252 of the pressure buffering room 233 is formed in the base film 251 by removing the sites exposed in the opening 266 of the base film 251 with Deep RIE used; thereafter, the mask 264 is removed, as illustrated in FIG. 12C.

Next, when the insulating film 243 and the insulating 245 are etched with BHF used by masking the base film 251 and the semiconductor film 222, the sound perception unit of the capacitor microphone 21, illustrated in FIG. 8, is obtained. Remaining parts of the pressure buffering room 233 and the pressure room 246 are formed by etching liquid that reaches to the insulating films 243 and 245 from the pressure buffering room 233 formed on the base film 251 and the acoustic hole 218 formed on the semiconductor film 222, then the insulating films 243 and 245 are etched.

As described above, using a well-understood manufacturing process for semiconductor devices including the step of doping impurities to a part of the semiconductor film 222 allows capacitor microphones with high sensitivity to be manufactured with low costs.

### Fifth Embodiment

The second impurities that form a conductive type semiconductor opposite to the central unit 214 may be diffused with low concentrations into the nearby edge 220 of the back plate 210 (refer to FIGS. 8A and 8B). In the above manufacturing method, for example, the second impurities that form the conductive type semiconductor opposite to the central unit 214 are doped across the semiconductor film 222 by ion-implanting before a mask 260 for ion-implanting the impurities formed on a region that supports the central unit 214 of the back plate 210 on the semiconductor 222 (refer to FIG. 11B). A p-n junction diode D is, therefore, formed on the back plate 210 as an equivalent circuit, illustrated in FIG. 9C. Since electrical barriers can be larger between the central unit 214 and the nearby edge 220 by means of setting the p-n junction diode D into an inverted bias state, sensitivity can be further improved. It should be noted that the second impurities may be ion-implanted into a region supporting the nearby edge 220 of the back plate 210 on the semiconductor 222 after ion-implanting the first impurities into a region supporting the central unit 214 of the back plate 210 on the semiconductor 222.

### INDUSTRIAL APPLICABILITY

The present invention can be applied to a method for manufacturing capacitor microphones with low manufacturing costs and high sensitivity.

1. A capacitor microphone comprising:
a plate having a fixed electrode;
a diaphragm having a variable electrode and vibrating by sound waves; and
a spacer insulating and supporting the plate and the diaphragm and forming airspace between the fixed electrode and the variable electrode, wherein
at least either of the plate or the diaphragm is a semiconductor single-layered film or a metal single-layered film whose specific resistance in a nearby edge close to the spacer is higher than a specific resistance in a central unit away from the spacer.

2. The capacitor microphone according to claim 1, wherein impurities are diffused in the nearby edge.

3. The capacitor microphone according to claim 1, wherein the central unit is formed with silicone and the nearby edge is formed with nitriding silicon.

4. The capacitor microphone according to claim 1, wherein the central unit is formed with silicone and the nearby edge is formed with oxynitriding silicon.

5. The capacitor microphone according to claim 4, wherein film thickness of the nearby edge is thicker than that of the central unit.

6. A method for manufacturing a capacitor microphone equipped with a plate having a fixed electrode, a diaphragm having a variable electrode and vibrating by sound waves, and a spacer insulating and supporting the plate and the diaphragm and forming airspace between the fixed electrode and the variable electrode, comprising the steps of:
forming a semiconductor single-layered film or a metal single-layered film to provide at least either the plate or the diaphragm; and
changing a specific resistance in a nearby edge of the semiconductor single-layered film or the metal single-layered film close to the spacer to be higher than a specific resistance in a central unit away from the spacer.

7. The method for manufacturing a capacitor microphone according to claim 6, wherein the step of changing is performed by ion-implanting in a state that the central unit of the semiconductor single-layered film or the metal single-layered film is kept masked.

8. The method for manufacturing a capacitor microphone according to claim 6, wherein the step of changing is performed by ion-implanting the semiconductor single-layered film or the metal single-layered film in a state that the central unit of the semiconductor single-layered film or the metal single-layered film is kept masked, and by activating the ion by annealing.

9. The method for manufacturing a capacitor microphone according to claim 6, wherein the step of changing is performed by thermal oxidation in a state that the central unit of the semiconductor single-layered film is kept masked.

10. The method for manufacturing a capacitor microphone according to claim 6, wherein the step of changing is performed by plasma polymerization in a state that the central unit of the semiconductor single-layered film or the metal single-layered film is kept masked.

11. A capacitor microphone comprising:
a plate having a fixed electrode and through-holes;
a diaphragm having a variable electrode and vibrating by sound waves; and
a spacer insulating and supporting the plate and the diaphragm and forming airspace between the fixed electrode and the variable electrode, wherein
at least either of the plate or the diaphragm is a semiconductor single-layered film whose specific resistance in at least a part of a nearby edge close to the spacer is higher than a specific resistance in the remaining units.

12. The capacitor microphone according to claim 11, wherein the semiconductor single-layered film contains impurities as donors or acceptors in the central unit, the impurities in the central unit being diffused with concentration higher than at least one part of the nearby edge.

13. The capacitor microphone according to claim 12, wherein the semiconductor single-layered film contains the first impurities and the second impurities for forming an inverted conductive type semiconductor surrounding the central unit, the second impurities being diffused with concentration lower than a concentration of the first impurities.

14. A method for manufacturing a capacitor microphone equipped with a plate having a fixed electrode and through-holes, a diaphragm having a variable electrode and vibrating by sound waves, and a spacer insulating and supporting the plate and the diaphragm to form airspace between the fixed electrode and the variable electrode, comprising the steps of:
forming a semiconductor film to provide at least either of the plate or the diaphragm; and
doping impurities acting as donors or acceptors in the central unit with concentration higher than at least a part of a nearby edge close to the spacer of the semiconductor film.

15. The method for manufacturing a capacitor microphone according to claim 14, further comprising the steps of:
ion-implanting the impurities to the semiconductor film,
annealing the semiconductor film after ion-implanting the impurities.

16. The method for manufacturing a capacitor microphone according to claim 14, further comprising the step of doping first impurities as the impurities and second impurities for forming an inverted conductive type semiconductor at a portion surrounding the central unit.

17. The method for manufacturing a capacitor microphone according to claim 15, further comprising the step of doping first impurities as the impurities and second impurities for forming an inverted conductive type semiconductor at a portion surrounding the central unit.
